(19) United States
(12) Patent Application Publication
(10) Pub. No.: US 2013/0031086 A1
(43) Pub. Date: Jan. 31, 2013

(54) PROCESS AUTOMATION SYSTEM PROBLEM ANALYSIS TOOL

(71) Applicants: Martin STRELEC, Chodov (CZ); Petr STLUKA, Prague (CZ)

(72) Inventors: Martin STRELEC, Chodov (CZ); Petr STLUKA, Prague (CZ)

(73) Assignee: HONEYWELL INTERNATIONAL INC., Morristown, NJ (US)

(21) Appl. No.: 13/190,134

(22) Filed: Jul. 25, 2011

(51) Int. Cl. G06F 17/30

(52) U.S. Cl. 707/722; 707/E17.014

(57) ABSTRACT

An automated data processing method includes providing a plurality of incident data from a physical installation of a process automation system in a processing facility that collectively spans a period of time and building a stored relational database including database data from the incident data. The method includes automatically generating at least one processed data result from the database data, wherein the automatically generating generates at least one processed data result from the database data. The processed data result is in a displayable form that facilitates identification of a problem in the process automation system by an analyst in a remote support center.

### FIELD

Disclosed embodiments relate to the field of process automation systems, and more particularly to the management of problems exhibited by process automation systems.

### BACKGROUND

A process automation system refers to a control system, usually of a manufacturing system or process in which the controller elements may or may not be central in location. In a distributed implementation, called a distributed control system (DCS), the controller elements are distributed throughout the control system with each component sub-system controlled by one or more controllers. The distributed system of controllers may be connected by a network for communication and monitoring.

A process automation system will typically have a problem report system wherein log messages related to problems or failures of various software and hardware components of the process automation system are generated. There is a large variety of different error messages, process identifiers and other data that may be written in a log message. Such logs may include, for instance, information about excessive usage of memory or central processing unit (CPU), as well as information about events, such as lost connection between a station and a server. Logs are typically stored in text files, which are viewed by individuals, such as support engineers, or analysts attempting to discern the problem being reported. Lengthy text files, however, can be difficult and tedious to review manually. Consequently, it can be time-consuming for an individual to pore over extensive lists of text in order to identify and isolate problems. Further, this manual process is prone to human error.

One existing approach to handling log messages includes an interface that highlights certain logs or log properties and provides basic log message visualization. This approach, however, leaves it up to the support engineer or analyst to discern the frequency of certain messages, the relationship between the messages and the time each message was transmitted. Consequently, this approach requires a human operator to wade through large amounts of textual data when attempting to identify the cause of a problem in various software and hardware components of the process automation system, which is time consuming and prone to human error. Therefore, there is a need for a more efficient method and system for facilitating an individual such as a support engineer or analyst in determining the causes of problems exhibited by process automation systems.

### SUMMARY

Disclosed embodiments include an automated data processing method. The method includes providing a plurality of incident data (e.g., in the form of log messages) from a physical installation of a process automation system in a processing facility that collectively spans a period of time, and building a relational database including database data from the incident data. The method further includes data processing that automatically generates at least one processed data result from the database data, such as the frequency by type of message, and the relationship between the messages. The processed data result is in a displayable form (e.g., graph form) that upon display facilitates identification of a problem in the process automation system by an individual, such as an analyst or a support engineer.

A system for performing automated data processing includes a receiver for receiving a plurality of incident data from a physical installation of a process automation system in a processing facility that collectively spans a period of time, and a non-transitory machine readable storage device for storing database data from the incident data. The system further includes a processor configured for automatically generating at least one processed data result from the database data, wherein the processed data result is in a displayable form that facilitates identification of a problem in the process automation system by an individual, such as an analyst.

### BRIEF DESCRIPTION OF THE DRAWINGS

FIG. 1 is an example illustration of a remote support center system shown in conjunction with a process automation system in an industrial facility, according to an example embodiment.

FIG. 2 is a flow chart illustrating the control flow of an example method for performing automated data processing, according to an example embodiment.

FIG. 3 is graph illustrating a trend graph showing the trend of log messages over time, according to an example embodiment.

FIG. 4 is histogram illustrating a frequency of log messages corresponding to each process identifier over a specified time interval, according to an example embodiment.

FIG. 5 is graph illustrating time on the x-axis, process identifiers on the y-axis and wherein frequency of log messages corresponding to each process identifier over a specified time interval is indicated by shading, according to an example embodiment.

FIG. 6 is a screenshot of an example user interface including a tree graph showing a list of process identifiers and a list of corresponding log messages nested within each process identifier, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments. One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

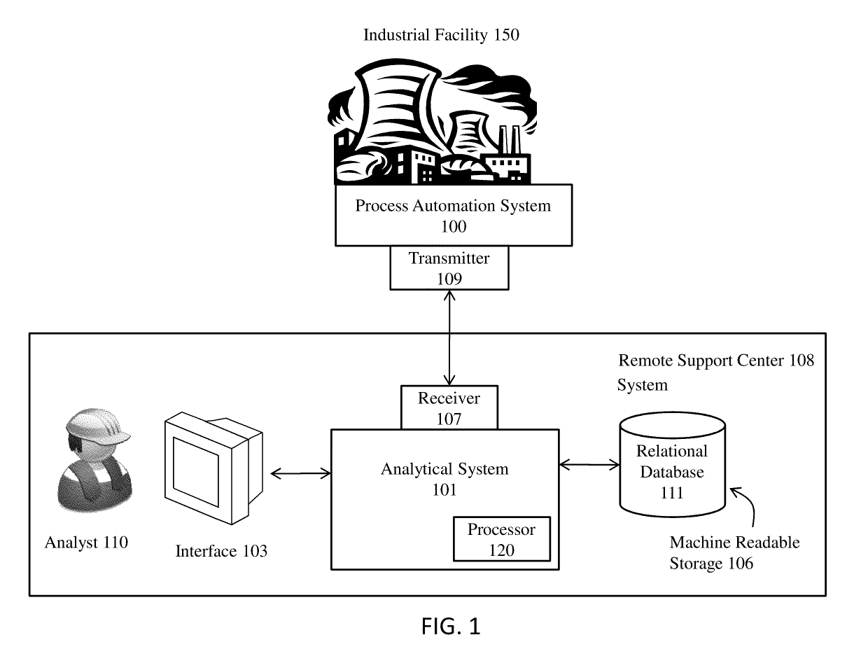

Disclosed embodiments include methods and systems for performing automated data processing of log messages, or incident data, in order to determine the cause of problems or failures of various software or hardware components of the process automation system. FIG. 1 is an example illustration of a remote support center system 108 shown in conjunction with a process automation system 100 deployed in an industrial facility 150, according to an example embodiment. An analytical system 101 is placed in the remote support center system 108 that includes at least one processor 120, such as a digital signal processor. The process automation system 100 is a control system including controller elements that may or may not be central in location. In a distributed implementation, the process automation system 100 is a DCS wherein the controller elements are distributed throughout the control system with each component sub-system controlled by one or more controllers.

The analytical system 101 deployed in the remote support center system 108 receives information about process automation system 100 deployed in the industrial facility 150, which may be a power plant, in one particular example. Namely, the process automation system 100 sends to the analytical system 101 log messages, or incident data, from its various software and hardware components distributed throughout the industrial facility 150 pertaining to problems or failures of those software and hardware components, i.e., incidents. A software process ran by a hardware component may comprise multiple threads. The term “log” or “log message” is herein used to refer to a message that may include a date/time stamp, a process identifier, a thread identifier, an error message or other data surrounding the problem being reported. A log may be in the form of a text message.

Below is a textual example of a log message, wherein “28-Oct-10” represents the date of the message, “14:34:34.5998” represents the time of the message, “9416” represents an identifier for the software process that spawned the message, “8216” represents an identifier for the thread within the software process that spawned the message, “gdamngr.exe:cdadll.cpp” usually represents the name of the software process in the message, and “GUninitialize( ) called” represents an error message, which may indicate a line of source code that caused the error or failure that spawned the message.

28-Oct-10 14:34:34.5998 (9416 8216) gdamngr.exe:cdadll.cpp:1: GUninitialize( ) called

In summary, the log message above indicates that on the identified date and time, the software process named “gdamngr.exe:cdadll.cpp” generated a “GUninitialize( )” error message, which indicates an error in setting a variable. The log messages received from the process automation system 100 installed in the industrial facility 150, as well as any other data calculated or generated by analytical system 101, may be stored in non-transitory machine readable storage 106 as a relational database 111 comprising database data.

The relational database 111 is sourced from the incident data. A “relational database” as used herein is a database that matches data by using common characteristics found within the data set, and the resulting groups of data are organized for ease of understanding. Such a grouping uses the relational model. Accordingly such a database is called a “relational database.” The software used to do this grouping is generally called a relational database management system (RDBMS).

In one particular embodiment, the relational database 111 comprises a Structured Query Language (SQL) database that can be stored in memory associated with a database server. SQL can be employed to access data, and also to define the form of the database, i.e., describe the tables, and describe indexes and views of the tables and other objects of the database. SQL is a high level programming language specifically designed for the database product, and permits a user to access or define elements without resorting to a lower-level language or assembly.

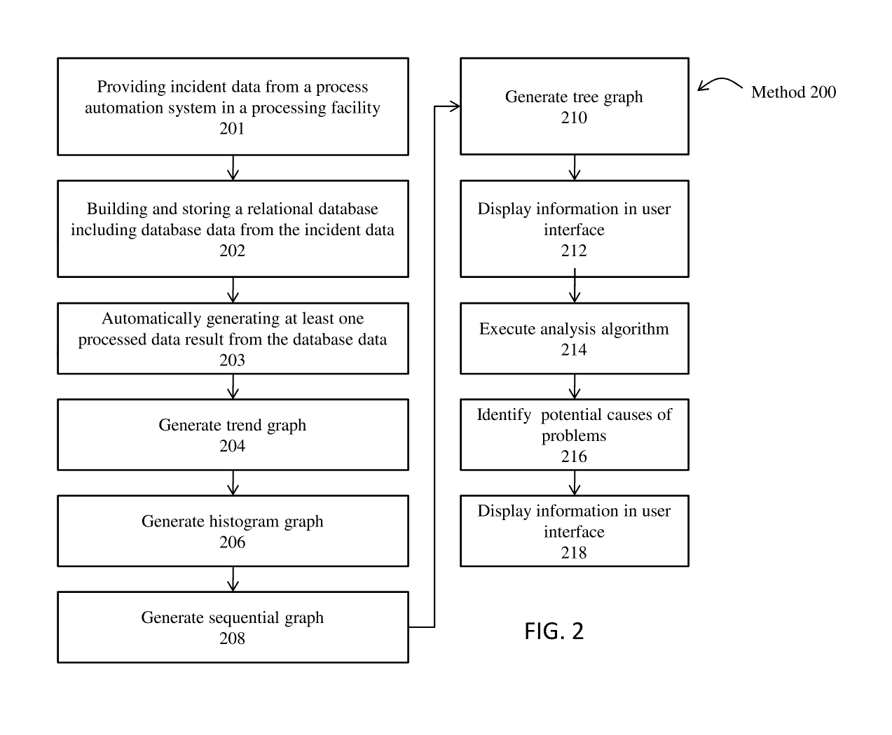

As explained in greater detail below with reference to FIG. 2, the analytical system 101 generates graphical user interfaces and data garnered from the process automation system 100, such as a DCS system, installed in the industrial facility 150, and displays it for an individual, such as an analyst 110 (or support engineer) via a user interface 103. The analytical system 101 may receive data from the process automation system 100 installed in the industrial facility 150 via a receiver 107, which may be a wired or wireless network interface card, for example. Process automation system 100 sends the data to the analytical system 101 via transmitter 109, which may be a wired or wireless network interface card, for example. The user interface 103 may comprise a computer with a display, a processor, and user input devices, such as a keyboard, mouse, touch screen and/or a microphone.

FIG. 2 is a flow chart illustrating a control flow for an example method 200 for performing automated data processing, according to an example embodiment. In a first step 201, analytical system 101 is provided a plurality of incident data generally in the form of log messages received from the process automation system 100 installed in the industrial facility 150, that collectively spans a period of time. The log messages can be in the form of text files that may include a date/time stamp, a process identifier, and an error message.

Step 202 comprises building a relational database 111 including database data comprising the incident data, such as in the form of log messages, where the analytical system 101 stores the relational database 111 on non-transitory machine readable storage 106. In step 203, processor 120 of the analytical system 101, running a disclosed algorithm, processes the incident data stored in the relational database 111 and automatically generates at least one processed data result that is in a displayable form which facilitates identification of a problem at the process automation system 100 deployed in the industrial facility 150 by an individual, for display on user interface 103.

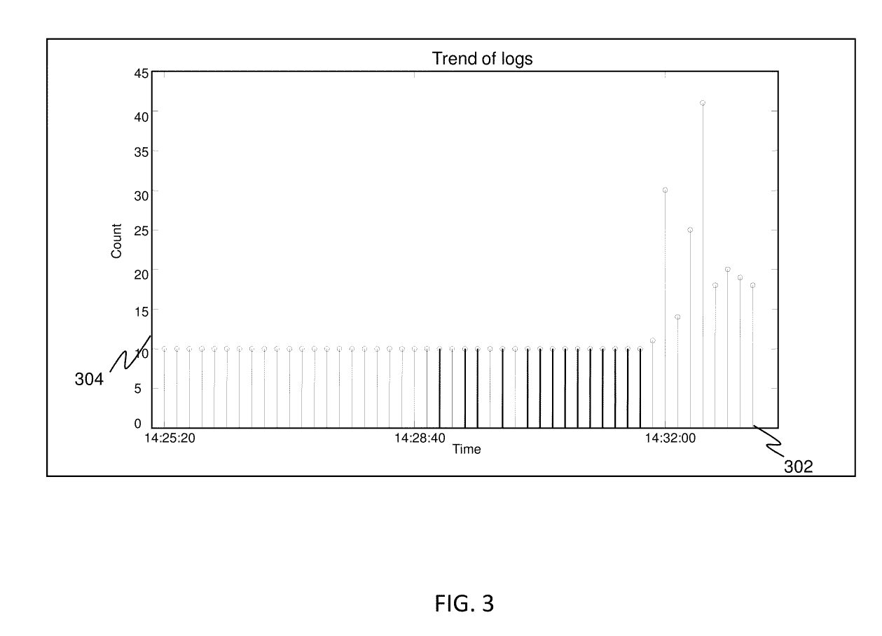

The displayable form can comprise one or more graphical representations of the data stored in the relational database 111, as shown in the example user interfaces of FIGS. 3 through 6, such as a trend graph (step 204), a histogram graph (step 206), a sequential graph (step 208), or a tree graph (step 210). Although the control flow of the method of FIG. 2 includes the generation of the graphical representations of steps 204, 206, 208 and 210, the method 200 supports the generation of one or more of the graphical representations recited above. The displayable form can also comprise non-graphical representations as well. For example, the results from the below described data mining and artificial intelligence algorithms may be output in standard textual format wherein the produced text identifies a faulty process, a cause of the incident data or a known fix for an identified problem.

In step 204, processor 120 of the analytical system 101, running a disclosed algorithm, can generate a trend graph, such as shown in FIG. 3, which depicts a continuous time interval along the x-axis 302 and a total count of log messages along the y-axis 304. The trend graph of FIG. 3 facilitates the identification of time intervals wherein a large or aberrant number of incidents were recorded, thereby highlighting the time of occurrence of a failure or error of various software and hardware components of the process automation system 100 installed in the industrial facility 150.

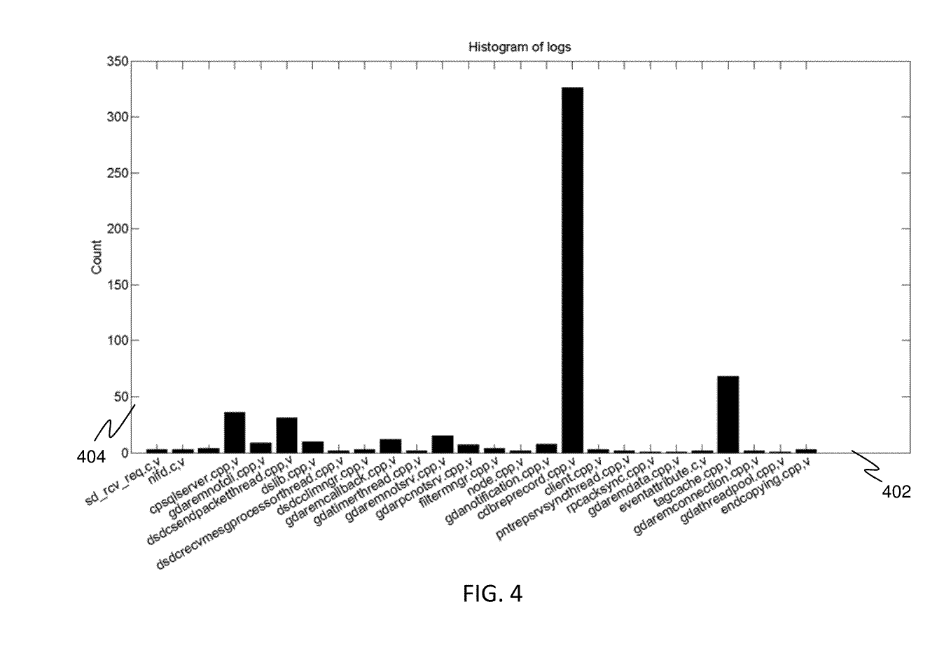

In step 206, processor 120 of the analytical system 101, running a disclosed algorithm, processes the log messages stored in relational database 111 and can generate a histogram illustrating a frequency of log messages corresponding to each process identifier over a specified time interval, as shown in FIG. 4. The histogram of FIG. 4 depicts a list of example software process identifiers along the x-axis 402 and a total count of log messages pertaining to each software process, over a specified time interval, along the y-axis 404. The histogram of FIG. 4 facilitates the identification of software components of the process automation system 100 deployed in industrial facility 150 that spawned or caused an inordinate number of incidents over a period of time.

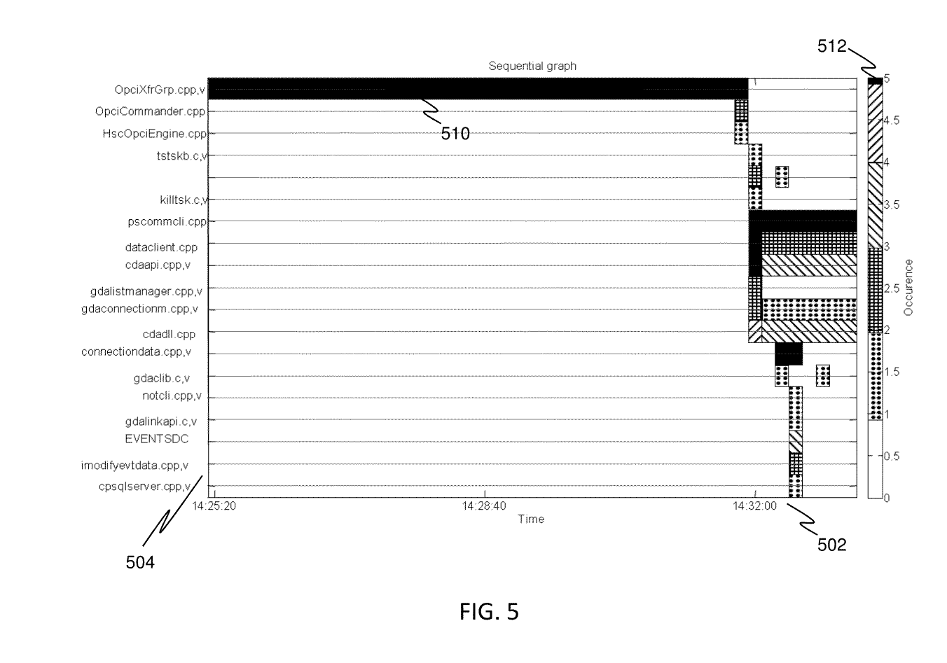

In step 208, processor 120 of the analytical system 101, running a disclosed algorithm, processes the incident data, such as log messages, stored in the relational database 111, and can generate a sequential graph, as shown in FIG. 5, illustrating which software processes caused defined numbers of incidents over specified periods of time. FIG. 5 shows a continuous time interval along the x-axis 502, and a list of software process identifiers on the y-axis 504, wherein frequency of log messages corresponding to each software process identifier over a specified time interval is indicated by shading in the graph (but can be indicated in other formats, such as by color). The legend 512 of FIG. 5 indicates the number of occurrences of log messages over specified time interval. For example, FIG. 5 shows that software process “OpciXfrGrp.cpp,v” (at the top of the y-axis 504) exhibited more than five (5) log messages for each time interval from 14:25:20 through about 14:32:00, as indicated by shading block 510. The sequential graph of FIG. 5 facilitates the identification of software processes of the process automation system 101 installed in the industrial facility 150 that caused a high number of log messages over a period of time, as compared to other software processes.

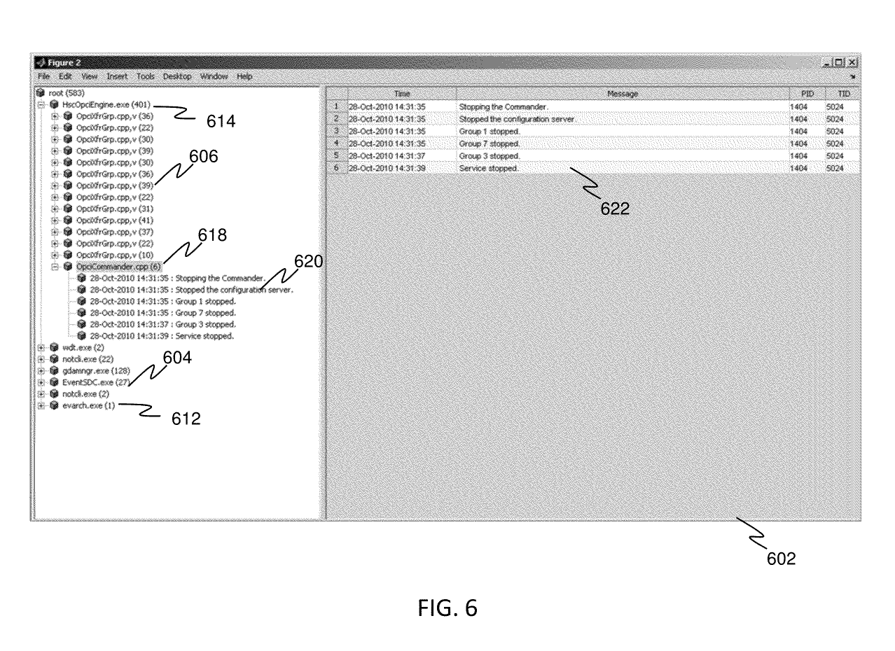

In step 210, processor 120 of the analytical system 101, running a disclosed algorithm, processes the incident data stored in machine readable storage 106 as relational database 111, such as in the form of log messages, and can generate a tree graph, as shown in FIG. 6. The tree graph 602 of FIG. 6 shows a list of software process identifiers 604 in a left-hand field. Note that each software process identifier 604 includes a number 612 in parentheses, which may indicate a number of log messages exhibited by that software process over a predefined period of time. When a software process identifier, such as the software process identifier shown as 614, is selected or activated via the user interface 103 by analyst 110, a list of corresponding thread identifiers 606 nested within the software process identifier 614 are displayed underneath the software process identifier 614. Note that each thread identifier includes a number in parentheses, which may indicate a number of log messages exhibited by that thread over a predefined period of time.

Another function of the tree graph 602 of FIG. 6 may include showing a list of log messages pertaining to a single thread. When a thread identifier, such as thread identifier 618, is selected or activated via the user interface 103 by analyst 110, a list of corresponding log messages 620 nested within the thread identifier 618 can be displayed underneath the thread identifier 618 and in window 622. Note that window 622 displays the pertinent log messages in column/row format, wherein a date/time stamp, an error message, a processor identifier and a thread identifier are shown for each log message.

In step 212, processor 120 of the analytical system 101, running a disclosed algorithm, displays one or more of the graphical representations of FIGS. 3 through 6 in the interface of 103 for viewing by analyst 110. In step 214, the analytical system 101 executes an analysis algorithm based on data of the incident data, such as in the form of log messages stored in the relational database 111 in order to identify the cause or causes of an error state or failure in the process automation system 100 installed in the industrial facility 150. In one embodiment, step 214 may include the use of data mining techniques that include conducting analysis on defined queries of a user such as analyst 110. In one example embodiment, a user, such as analyst 110, may define certain SQL queries that identify problem sources, such as an SQL query that searches the relational database 111 for software process identifiers associated with at least a specified number of log messages over a predefined threshold. Upon execution of said SQL queries, those software process identifiers meeting the query requirements are recognized as potential causes of a problem or problems.

In another embodiment, step 214 may further include the use of artificial intelligence algorithms configured for obtaining knowledge from the incident data, such as in the form of log messages, stored in relational database 111 and discerning a cause of the problems reported by the log messages. The aforementioned algorithms may analyze the correlation among particular incidents in order to discern and store, for future use, patterns that lead to indications of an incident. For example, a particular stored pattern may include a list of process/thread identifiers, a time profile that indicates when the aforementioned process/thread identifiers are featured in log messages, and a log message count profile that indicates the number of log messages that are associated with each process/thread. Also associated with the stored pattern may be a cause of the incident and a known fix for the problem. In this example, the processor 120 of analytical system executes the aforementioned artificial intelligence algorithms to compare current log message activity against the stored pattern. If there is a match between the current log message activity and the stored pattern, the analytical system 101 may then conclude that the cause of the incident associated with the stored pattern, and the corresponding fix, are related to the current log message activity.

In step 216, the analytical system 101 automatically identifies information associated with a cause of the problem instigating the log messages, and/or a fix for the problem, according to the algorithm(s) executed in step 214 and in step 218 displays the information in the user interface 103 for the analyst 110 or other individual.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

As will be appreciated by one skilled in the art, the subject matter disclosed herein may be embodied as a system, method or computer program product. Accordingly, this Disclosure can take the form of an entirely hardware embodiment, an entirely software embodiment (including firmware, resident software, micro-code, etc.) or an embodiment combining software and hardware aspects that may all generally be referred to herein as a “circuit,” “module” or “system.”Furthermore, this Disclosure may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include non-transitory media including the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device.

Computer program code for carrying out operations of the disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The Disclosure is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a physical computer-readable storage medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

We claim:

1. An automated data processing method, comprising:
providing a plurality of incident data from a physical installation of a process automation system in a processing facility that collectively spans a period of time;
building a relational database including database data from the plurality of incident data, wherein the relational database is stored on non-transitory machine readable storage and
automatically generating at least one processed data result from the database data,
wherein the processed data result is in a displayable form that facilitates identification of a problem at the processing facility by an individual.

2. The method of claim 1, wherein the relational database comprises a Structured Query Language (SQL) database stored in a SQL server.

3. The method of claim 1, wherein the processed data result comprises at least one of a graphical depiction including the database data, results from data mining the database data, and artificial intelligence derived knowledge obtained from the database data.

4. The method of claim 1, further comprising displaying the processed data result on a user interface.

5. The method of claim 1, wherein each of the plurality of incident data is provided in a form of a log file, including a date/time stamp, a process identifier, and an error message.

6. The method of claim 5, wherein the processed data result comprises a graph showing a frequency of the plurality of incident data corresponding to each the process identifier over a time interval and wherein the processed data result is displayed on a user interface.

7. The method of claim 5, wherein the processed data result comprises a graph showing time on an x-axis and the process identifiers on a y-axis, wherein frequency of incident data corresponding to each of the process identifiers over a time interval is indicated by a color or pattern and wherein the processed data result is displayed on a user interface.

8. The method of claim 5, wherein the processed data result comprises a tree graph showing a list of the process identifiers and a list of corresponding ones of the plurality of incident data nested within each the process identifier, and wherein the processed data result is displayed on a user interface, further wherein when the plurality of incident data is selected via the user interface, information associated with the incident data is displayed on the user interface.

9. The method of claim 5, wherein the processed data result comprises a tree graph tree graph showing a list of the process identifiers and a list of corresponding thread identifiers nested within each the process identifier, and wherein the processed data result is displayed on a user interface, further wherein when a thread identifier is selected via the user interface, a list of corresponding ones of the incident data is nested within each thread identifier is displayed on the user interface.

10. The method of claim 9, wherein the processed data result further comprises a tree graph showing a list of thread identifiers and a list of corresponding ones of the incident data nested within each thread identifier, wherein when the incident data is selected via the user interface, information associated with the incident data is displayed on the user interface.

11. The method of claim 1, wherein the processed data result comprises a graph showing a total count of the incident data over time and wherein the processed data result is displayed on a user interface.

12. The method of claim 1, further comprising:
executing an analysis algorithm upon the incident data;
identifying information associated with a cause of the incident data according to the analysis algorithm, and
displaying the information in a user interface.

13. A system for performing automated data processing, comprising:
a receiver for receiving a plurality of incident data from a physical installation of a process automation system in a processing facility that collectively spans a period of time;
a non-transitory machine readable storage for storing a relational database comprising database data from the incident data, and
a processor configured for automatically generating at least one processed data result from the database data,
wherein the processed data result is in a displayable form that facilitates identification of a problem in the process automation system by an analyst in a remote support center.

14. The system of claim 13, further comprising a user interface for displaying the at least one processed data result.

15. The system of claim 13, wherein the non-transitory machine readable storage comprises a relational database including a Structured Query Language (SQL) database stored in a SQL server.

16. The system of claim 13, wherein the incident data is provided in a form of a log file including a date/time stamp, a process identifier, and an error message.

17. The system of claim 16, wherein the processed data result comprises a graph showing a frequency of the plurality of incident data corresponding to each the process identifier over a time interval.

18. The system of claim 13, wherein the processed data result comprises a graph showing a total count of the plurality of incident data over time.

19. The system of claim 13, wherein the processed data result comprises at least one of graphical depiction including a plurality of the database data, results from data mining the database data, and artificial intelligence derived knowledge from the database data.
